(19) United States
(12) Patent Application Publication
(10) Pub. No.: US 2024/0227603 A9
(43) Pub. Date: Jul. 11, 2024

(54) Electric Vehicle Onboard Charge Distribution System

(71) Applicant: Stephen Sophorn Lim, N. Palm Springs, CA (US)

(72) Inventor: Stephen Sophorn Lim, N. Palm Springs, CA (US)

(21) Appl. No.: 17/971,360

(22) Filed: Oct. 21, 2022

(51) Int. Cl. B60L 53/57; B60L 53/16; B60L 53/68; H02J 7/34

(52) U.S. Cl. CPC B60L 53/57; B60L 53/16; B60L 53/68; H02J 7/342

(57) ABSTRACT

An Electric Vehicle onboard program feature that provides charge assistance to other EV requiring roadside assistance (EV2EV) called the EV Onboard Charge Distribution System. An EV Owner/Operator who did not make it to the next charging station could implement a smart phone APP and/or other means of implementing the onboard charge to share program menu screen to locate other EV Owner/Operators participants in the program to share their EV driving distance charges. The EV onboard menu called the Charge2Share onboard program feature works hand in hand with a Smart Phone APP and/or others, with the EV Owner/Operator first registering into a website, example www.EVChargetoShare.com, www.evcharge2share.com or a similar website to setup an account. The EVCharge2Share onboard program feature contains a payment system that allows EV Owner/Operator participants to earn some cash and/or credit for their next driving distance charge sharing services.

### BACKGROUND OF THE INVENTION

### Field of Invention

The Electric Vehicle (EV) appears to populate the street of America and top nations around the world. With the Electric Vehicle technology becoming abundance, a need for an emergency onboard charge to share system may be essential to assist Electric Vehicle that requires charging. There are many charge stations but when an Electric Vehicle runs out of charge in the middle of the road and couldn't make it to the next charge station for whatever reason, an EV with an onboard charge distribution system called the EV Onboard Charge Distribution System (EVOCDS) may be the solution to assist that EV in emergency.

### Description of Prior Invention

There are some inventions that provides roadside assistance for EV as an emergency charging like shared from Prosser et Al, U.S. Pat. No. 9,007,020, called “Charging Service Vehicle With Battery and Generator Sources” which is a roadside assistance vehicle that implement a combustion engine to revive a stalled EV using a generator. If the nowadays theme is to combat climate changes, take care of the environment; implementing an internal combustion vehicle may defeat the purpose but my respect to Prosser and team for participating in the EV industry to better the world. Implementing a vehicle like a Fuel Cell Vehicle truck may be a better approach, but the technology may still be in the Research and Development phase. This leads to the approach of the EV Onboard Charge Distribution System, a Charge to Share or “Charge2Share” program that allow charges be taken from the battery pack of one Electric Vehicle and share with another Electric Vehicle.

### Objects and Advantages

The EVOCDS invention introduces the Charge to Share, Charge2Share or EV2EV charge sharing program to other EV requiring charges; comprises of the charge distribution computer, onboard menu software program applicable with smart phone APP, for assisting other EV that requires charge can continue to the next destination. When implementing the Charge2Share program, EV Owner/Operator would register to have an account in a website called EVCharge2Share.com or evcharge2share.com and/or website designed for the Charge to Share program application; and complete the payment/credit system amongst other required information. The Charge2Share is a benefit to the EV Owner/Operator that works with a smart phone APP and/or Charge2Share onboard program and/or registration website, for monetary compensation in a form of cash and/or credit after assisting other EV Owner/Operator with their roadside assistance need in sharing a percentage of the travel distance of charges. The advantage of the having a charge distribution system program and hardware on every Electric Vehicle acts as a safety features to assist other stalled Electric Vehicle that requires just the charge to get to destination.

Another advantage for having an EV Onboard Charge Distribution System could be observed as an independent system that branches out of the EV battery pack. This product can be installed to earlier Electric Vehicle models that does not have an EVOCDS or as an aftermarket add on item to an EV. With an EVOCDS module or computer that distributes the appropriate charges and send information to the onboard screen for input/output application and/or smart phone APP. A separate discharge port is installed on the side of the EV to eliminate disruption of the standard charging port.

### SUMMARY OF THE INVENTION

As Electric Vehicles enter the automotive arena, so does the essential charging infrastructure that provides powers to the electric vehicle, and an emergency assistance of EV Owner/Operator requiring charges. There are many charging systems as companies that delivers fast charges and reliable system, but many charging stations does not cater to rescue an EV that run out of charges right in the middle of the road, boulevard, highway, freeway or back country road for emergency roadside assistance. This introduces the Electric Vehicle Onboard Charge Distribution System (EVOCDS), developed for every EV and EV manufacturer to consider, provides charge distribution feature to other EV Owner/Operator that require charging.

The invention of the Electric Vehicle Onboard Charge Distribution System comprises of the connection port, cables, charge distribution output, computer module, software programs onboard menu, Smart Phone APP and other essential devices/components. A connection port called a discharge port is a separate component to the EV, so that it doesn't interfere with the standard charge port on the EV, but if further R&D finds better design, the EVOCDS is not limit to modify design and approaches. The design approach to the EVOCDS hardware would contain an output plug with a computer module that is programmed to deliver a certain amount of distance driving charge from the providing EV battery pack. This system is ideal for an add-on aftermarket feature for EV2EV charging application but if EV manufacturers adapt the EVOCDS features to every Electric Vehicle as a standard, it would provide EV Owner/Operator peace of mind that an onboard Charge to Share system is there to implement. When life happens unexpectedly, like a little charge from another EV to get to a charging point or home charging destination can make a day go better.

### Hardware

The EVOCDS comprising of the EVOCDS Modules, Discharge Ports, Onboard Menu Screen, Connection Cables, and/or other components, is a charge distribution system that implements charges from the battery pack of an operational EV and delivers charges to EV requiring charges with a Charge to Share menu program that could be standard to all Electric Vehicles. The computer of the system is the EVOCDS Module that computes the charge distribution from the Electric Vehicle battery packs to the EV requiring emergency charges. The discharge port is made separate from the standard charge port of an EV is to eliminate the charge interference and/or any other factors that may disrupt the charge to share system, but is not limited to modification for a better application and performance development of the system.

### Software

The Charge to Share or “Charge2Share” program exhibit in the EV onboard menu screens allows for the EV Owner/Operator to either registers their information to commence Charge2Share program within the Electric Vehicle, Smart Phone App, and/or anywhere applicable internet of the program's website. Registering with the EVCharge2Share.com or evcharge2share.com website allows for login to see and set activities and other information; by either implementing the onboard EV menu, Smart Phone APP, and/or program's website. One main benefit to the EV Owner/Operator for implement the Charge to Share program is the monetary compensation of cash and/or credit that EV Owner/Operator retains for sharing their travel distance charge services.

### Implementing the Charge2Share Program

In case of an Electric Vehicle roadside emergency for requiring charges, due to the EV running out of charges in the middle of road somewhere before reaching a charging station; the EV Owner/Operator could open a Smart Phone APP called Charge2Share or similar APP to locate another EV Owner/Operator who participated in the Charge to Share program. The APP will contain the nearest participants with the charging applicable to provide, the cost rate amount and/or listed as a gift. If the stalled EV Owner/Operator has access to a computer with data connection, the same approach can be taken to locate the Charge to Share participants aside from implementing the EV Onboard Menu Screen and/or Smart Phone APP.

When the EV Owner/Operator meet at the EV stalled destination, both vehicles are linked via the Charge2Share either onboard EV menu computer, and/or on the Smart Phone APP with each assigned passwords to connect and verified and map of the charging connection for history record keeping, and with the option of each EV Owner/Operator to leave out personal information record. An acceptance button allows for the charge distribution to take place but prior to ensuring all cable connections and all safeties with a check box; as cash and/or credit and/or as a GIFT, charges are exchanged. An estimate time should be given and a notification on the Smart Phone APP will be notified and/or a flashing ready light about the plugs and/or discharge port, either green or blue or other completes the charge to share program.

The EVOCDS with Onboard Menu, EVCharge2Share.com or evcharge2share website, Smart Phone App, data, hardware and software information in the Figures are example of the menu, functions, and demonstrations at this time; for all programs, software, hardware and other essentials are subject to modification to accommodate Electric Vehicle designs, applications, performance, and other essentials in further development.

### BRIEF DESCRIPTION OF THE DRAWINGS

The following is a brief description of the illustration drawings with components, assemblies, and applications of the Electric Vehicle Onboard Charge Distribution System as a feature to the Electric Vehicle.

FIG. 1 illustrates an EV with a standard charge port that is situated in the rear of the vehicle; and the discharge port of the EVOCDS situated in the front of the vehicle.

FIG. 2 illustrates the discharge plug, designed to contain an easy to release toggle rod flushed at the socket insert and release handle.

FIG. 3 illustrates the standard charge port of an Electric Vehicle, for explanation of the EVOCDS application.

FIG. 4 illustrates the EVOCDS installed in an Electric Vehicle as a safety feature to share charge distribution to emergency assistance EV requiring charge to get to their next destination, which placements of each devices are subject to change due to onboard space availability and/or interior aesthetics and/or design modification to keep up with the EV technology.

FIG. 4A is a close up illustration of the Electric Vehicle Onboard Charge Distribution System consist of the EVOCDS Module, Discharge Port, Menu Screen, and the EV Battery Pack with wire connections to each peripheral devices.

FIG. 5 is an example of an information input format for the website login/registration of the example website www.EVChange2Share.com or www.evcharge2share.com like the EV Owner/Operator name, vehicle information, and other. Where the input information and aesthetic design is subject to modification to keep up with the EV technology.

FIG. 5a is an example of an information input format for the website login/registration of the example website www.EVChange2Share.com or www.evcharge2share.com like the EV Owner/Operator payment information, and other. Where the input information and aesthetic design is subject to modification to keep up with the EV technology.

FIG. 6 is an example of an information input format for the Charge2Share onboard menu screen; when implemented, the EV Owner/Operator input information with the amount of charge he/she is willing to share and allow an EV computer to calculate allowable amongst other options. Where the input information and aesthetic design is subject to modification to keep up with the EV technology.

FIG. 7 is an example of an information input format for the Charge2Share that is either in the onboard menu screen of an EV and/or a Smart Phone APP and/or registration website, developed for an EV Owner/Operator requiring emergency assistance for accepting driving distance charges to their stalled vehicle. Where the input information and aesthetic design is subject to modification to keep up with the EV technology.

FIG. 8 is an illustration of an EV2EV charging implementing the Charge2Share program, with a display of the onboard menu screen for an EV sharing the charge and a display of the Smart Phone APP for an EV accepting the charge for his/her drained battery that stalled in the middle of somewhere.

FIG. 9 is a color illustration of the EV2EV charging implementing the Charge2Share program, with all safety considered when connecting and allowing for the charge to transfer between Electric Vehicles.

### DRAWINGS

### Reference Numerals

| | | | |
|---|---|---|---|
| 200 | Charge Port | 250 | Charge Plug |
| 275 | Connection Cable | 300 | EVOCDS Module |
| 325 | Onboard Menu Screen | 330 | Onboard Menu Program |
| 340 | Smart Phone APP | 350 | Discharge Port |
| 375 | Discharge Plug | 380 | Release Rod |
| 385 | Release Handle | 400 | EV Battery Pack |

### DETAILED DESCRIPTION OF THE INVENTION

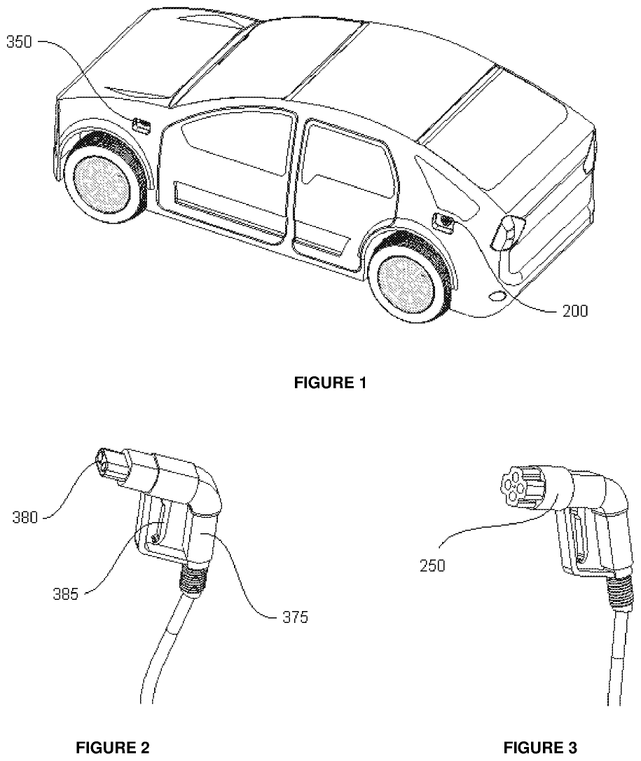

### FIG. 1—Embodiment

An embodiment of an Electric Vehicle body structure comprises of the Charge Port [200], standard of an EV, a Discharge Port [350], a separate output port of the EV Onboard Charge Distribution System of a functional EV to share charges with an EV requiring charge to reach the next destination.

### FIGS. 2—Embodiment

An embodiment of the Discharge Plug [375] comprises of an internal Discharge Release Rod [380] attached to the Discharge Release Handle [385] for an easy release feature after charging.

### FIGS. 3—Embodiment

An embodiment of the Charge Plug [250] is a standard for EV but an add on feature may consist of an internal Discharge Release Rod [380] attached to the Discharge Release Handle [385] for an easy release feature after charging; to explain the EVOCDS application.

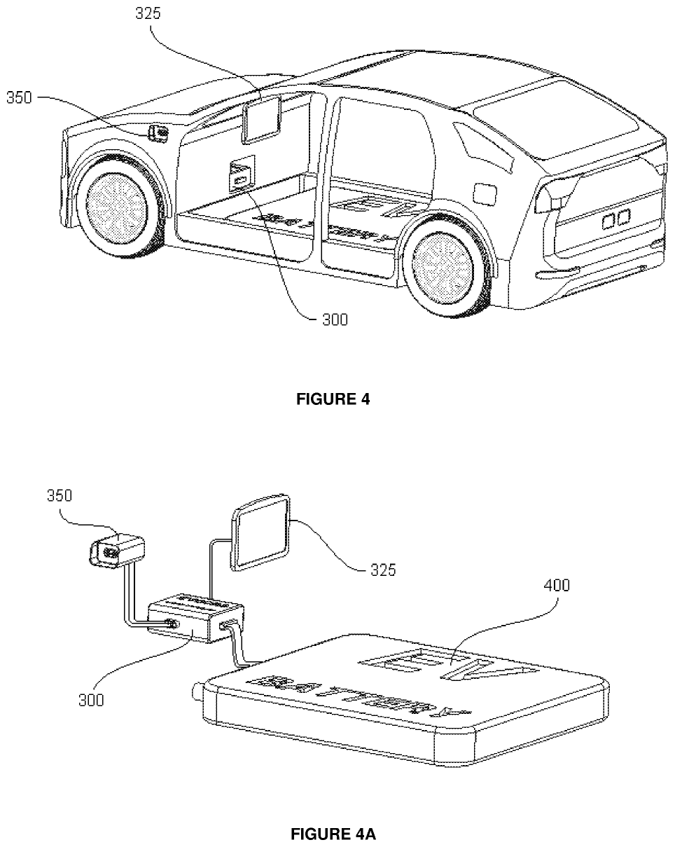

### FIG. 4—Embodiment

An embodiment of the of an EV Vehicle comprises of an installation of the EV Onboard Charge Distribution System consists of the EVOCDS Module [300], Onboard Screen [325], and the Discharge Port [350].

### FIG. 4A—Embodiment

An embodiment of the EV Onboard Charge Distribution System comprises of the EVOCDS Module [300], an Onboard Screen [325], and the Discharge Port [350] connected to each other.

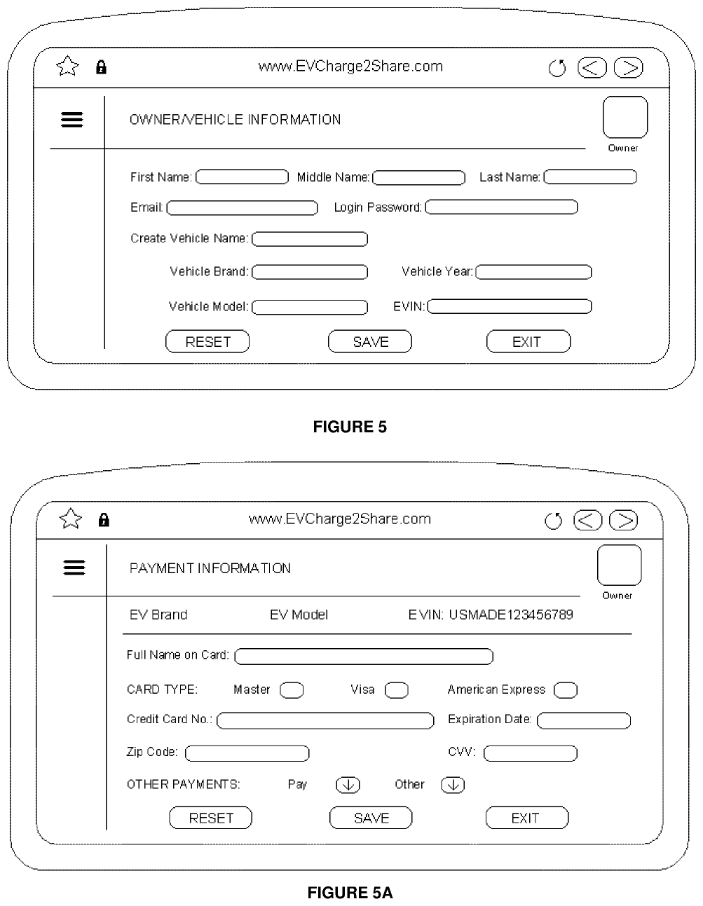

### FIG. 5—Embodiment

An embodiment of the EV Onboard Menu Screen [325] example comprises of a website www.EVCharge2Share.com or www.evcharge2share.com menu display for inputting registration that allows EV Owner/Operator to enter their Name, Middle Name, Last Name, Email and Password; and to Creates a Vehicle Name [alias or fictitious], Brand, Model, Year and Electric Vehicle Identification Number (EVIN) for the EV Owner/Operator information. The input information prompts in the Charge2Share Program is subject to modification as technology advances, which input contents may be added or remove depending on the EV design application theme and essential software program developments.

### FIG. 5A—Embodiment

An embodiment of the EV Onboard Menu Screen [325] example comprises of website www.EVCharge2Share.com or www.evcharge2share.com menu displays the EV Brand, EV Model and EVIN; for inputting Credit/Payment information, prompts allow the EV Owner/Operator to enter their Full Credit Card Information indicating the Type of Card, Credit Card Number, Expiration Number, Zip Code, and the CVV number; with other choices of Payment Type for the EV Owner/Operator Credit/Payment Information to be stored into the system. The input information prompts in the Charge2Share Program is subject to modification as technology advances, which input contents may be added or remove depending on the EV design application theme and essential software program developments.

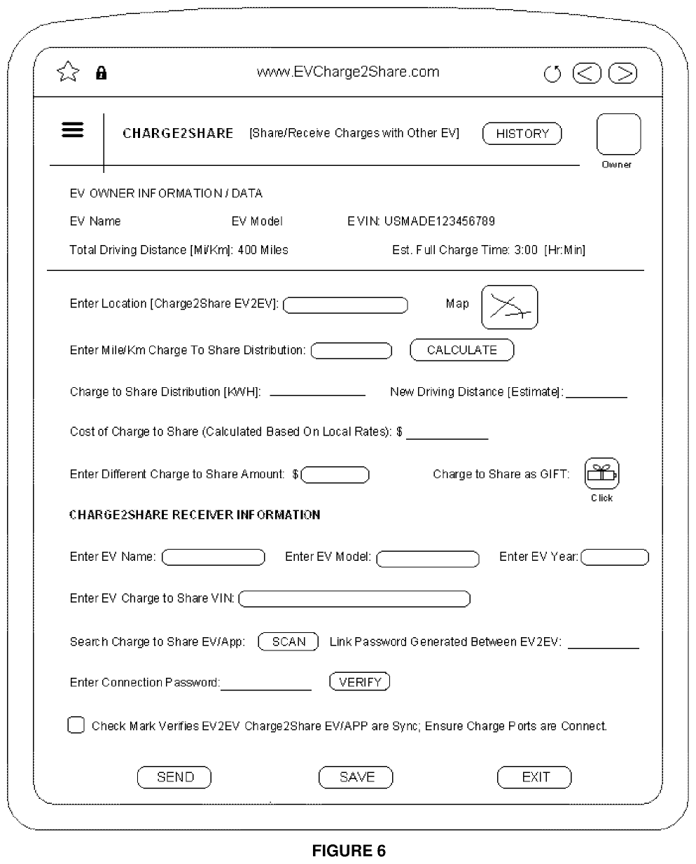

### FIG. 6—Embodiment

An embodiment an EV Onboard Menu Screen [325] comprises of an Onboard Menu Program [330] with a Charge2Share menu containing input information requirement to initiate a Charge to Share program of an EV. Within the program menu, there comprises of a History button, EV Owner/Operator Picture, vehicle information with Vehicle Name, Vehicle Model, Electric Vehicle Identification Number, Total Driving Distance and Estimate Full Charge Time; where required input information comprises of the Location of Charge Transfer with a Map, required Charge to Share Distribution Amount, Calculation button resulted with a Charge to Share Distribution and New Driving Distance, and Cost of Charge based on local rates. An option to change the Cost of the Charge to Share Amount or a button to click for Gift finishes the input information of the EV Owner/Operator providing the charges.

Followed by Charge2Share Receiver Information of the EV Owner/Operator receiving charges input information are as follows with the EV Name, EV Model, EV Year, Electric Vehicle Identification Number, a SCAN button to allow for password assigning and verification with the Verify button. A check mark ensures the cable connections are properly plugged and safeties are assessed. The input information prompts in the Charge2Share Program is subject to modification as technology advances, which input contents may be added or remove depending on the EV design application theme and essential software program developments.

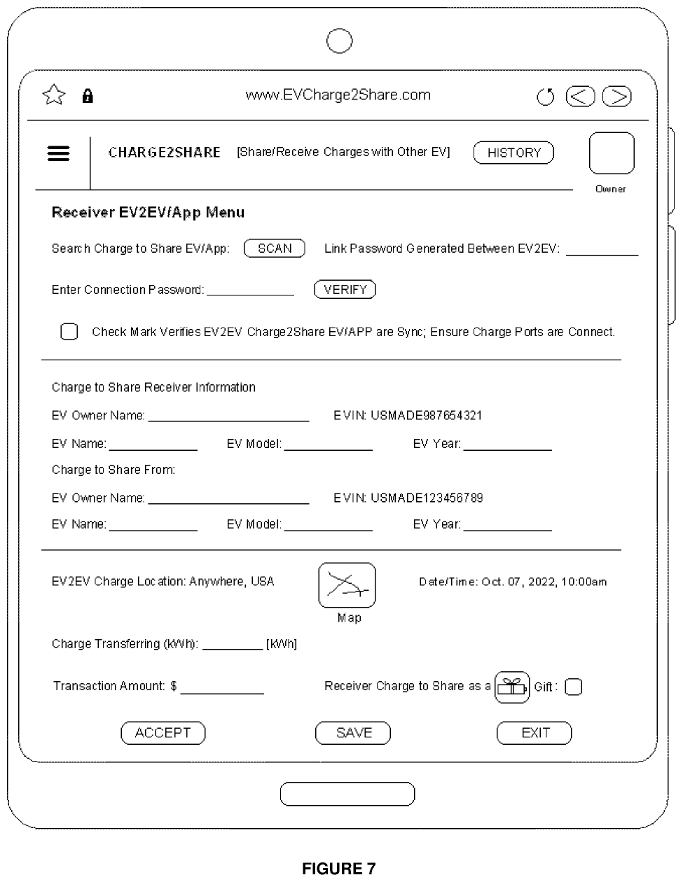

### FIG. 7—Embodiment

An embodiment an EV Onboard Menu Screen [325] comprises of an Onboard Menu Program [330] compatible with on a Smart Phone APP [340] with a Charge2Share menu containing input information requirement to initiate a Charge to Share program of an EV. Within the program menu comprises of a History button, EV Owner/Operator picture, SCAN for device button to generate Password to link between computers; along with each computer Password generated to connect. A Check Mark ensures the cable connections are properly plugged and safeties are assessed. A section containing both Electric Vehicle Owner/Operator information of the EV Owner Name, EVIN, EV Name, EV Model, EV Year. Another section of the Charge2Share menu provide an activity location of a Charge2Share with Date and Time Stamp, the Charge Distribution Transfer in KWh Unit along with the Amount in Dollars or as a Gift with a Gift check box to confirm. An Accept, Save, and Exit to leave menu. The input information prompts in the Charge2Share Program is subject to modification as technology advances, which input contents may be added or remove depending on the EV design application theme and essential software program developments.

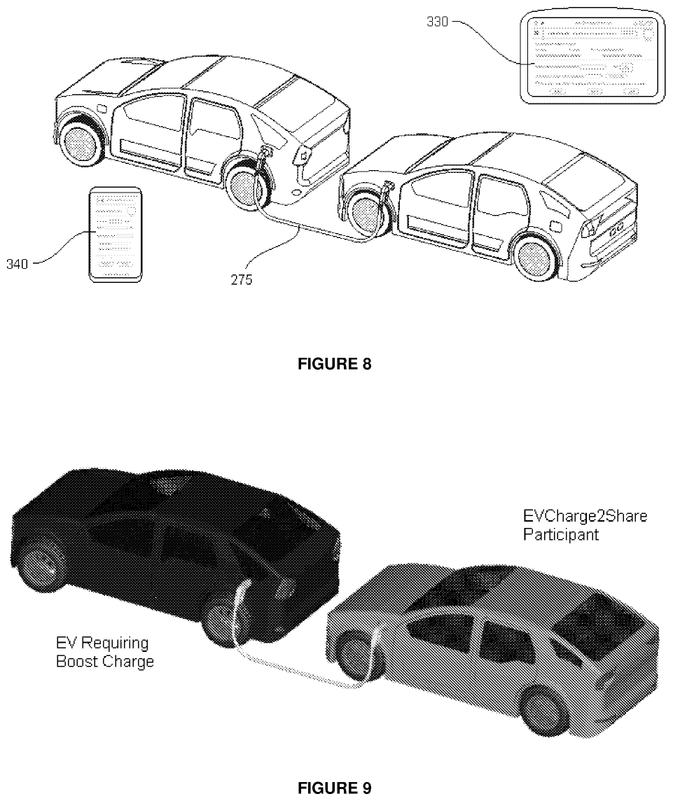

### FIG. 8—Embodiment

An embodiment displays an EV2EV implementing a Charge2Share Program consist of an Onboard Menu Program [330] connected by a Connection Cable [275] to the EV requiring charges to get the next destination. With a Smart Phone APP [340] for EV Owner/Operator requiring charges to input information of the Charge2Share Program and allow charges to share activities to his/her Electric Vehicle.

### FIG. 9—Embodiment

An embodiment, color version of an EV2EV implements a Charge2Share program of the EVOCDS to share charge between EV with a distance travel charge to EV requiring charges by means of a Connection Cable [275] from the Discharge Port [350] and Discharge Plug [375] to a Charge Port [200] and Charge Plug [250].

### OPERATIONS—FIGS. 2-3, 4-4A, 5-5A, 6, 7, 8 and 9

### FIG. 2-3

An embodiment of the Discharge Plug [375] and Charge Plug [250] consist of the Release Rod [380], positioned flushed with the electrical socket prongs; and the Release Handle [385], which both are connected, when triggers allows for the Discharge Release Rod [380] to pop out of the electrical socket prongs, there disconnects the Discharge Plug [375] or Charge Plug [250].

### FIG. 4-4A

An embodiment of the EV Onboard Charge Distribution System Module [300] is a computer that distribute charges from the EV Battery Pack [400] of a functional EV to an EV requiring charges through a Discharge Port [350], which is connected with the Discharge Plug [375], Connection Cable [275] and to the Charge Plug [250], Charge Port [200] from an EV sharing its reserve charge that implements the Charge2Share program. All input information requires in the Charge2Share onboard program menu and/or Smart Phone APP [340. Prior to implementing the Charge2Share program, EV Owner/Operator must register within the EVCharge2Share.com or evcharge2share.com website, later logins to make changes or edit to the saved information.

### FIG. 5

An embodiment of the Onboard Menu Screen [325] displays a menu screen for an EV Owner/Operator to register with the www.EVCharge2Share.com or www.evcharge2share.com website where input information requirement starts with a picture of the EV Owner/Operator, First Name, Middle Name, Last Name; an Email, Login password, Create a Vehicle Name. Input the Vehicle Brand, Vehicle Year, Vehicle Model, and EVIN. Completing the registration with a Reset button to clear and start input again, Save Button to save to come back later, and/or Exit Button to leave the program.

### FIG. 5A

An embodiment of the Onboard Menu Screen [325] displays a menu screen for an EV Owner/Operator to register with the www.EVCharge2Share.com or www.evcharge2share.com website where information requires Payment Information input, which starts with a picture of the EV Owner/Operator, EV Band, EV Model, EVIN of already input information from previous screen; the Name on the Credit Card, Type of Card, Credit Card Number, Expiration Date, Zip Code, and the CVV number. Other type of payment information can be added by pushing the Down Arrow button. Completing the Payment Information registration with a Reset button to clear and start input again, Save Button to save to come back later, and/or Exit Button to leave the program.

### FIG. 6

An embodiment of the Onboard Menu Screen [325] displays an EV onboard menu screen for an EV Owner/Operator to initiate the Charge2Share program where the onboard menu screen exhibit the EV Owner/Operator picture, a HISTORY button that contains all charge distribution services record. The next section is the EV Owner Information/Data that displays the EV Name, EV Model, an EVIN carried on from previous registration, the Total Driving Distance, and the amount of Full Charge Time. An input prompt requirement allows for input of the charging exchange location, with map. The Charge2Share allow for input the Charge to Share Distribution in kWh, where a CALCULATE button generates a new Charge to Share Distribution in kWh and an estimate New Driving Distance with Cost of Charge to Share figures. An option for the EV Owner/Operator to change to a different amount, or give as a Gift charge by clicking the Charge Gift icon button.

### FIG. 7

An embodiment of a Smart Phone APP [340] displays an EV Owner/Operator Picture with HISTORY button to call records of charge to share program service activities. For EV2EV computer connection, the Receiver EV2EV/APP Menu allows for EV Owner/Operator requiring charge to SCAN for EV Owner/Operator that is providing the charge to share, with a linking password assigned to provide to other EV Owner/Operator, while the other EV Owner/Operator provide theirs secure link between the EV2EV. A check mark finalize that all ports and cable connections are in place and safely secured. The next section provides information of both EV2EV Owner/Operators vehicle information along with each EVIN carried on from previous registration. On to the last section of the Smart Phone APP [340], provide a location and Map of the charge to share activities, Date and Time Stamp. A confirmation of the Charge Transferring in kWh with the Charge Transaction Amount in dollars or the EV Owner/Operator may receive the charge to share as a GIFT, which a check mark would indicate confirmation. Finalizing the Charge2Share Smart Phone App [340], the ACCEPT button is to proceed with charging the EV2EV, with the Save Button to save to come back later, and/or Exit Button to leave the program.

### FIG. 8-9

Upon completion of input information in the Charge2Share program either in the EV onboard menu screen, and/or in another computer, and/or in a Smart Phone APP, and after all connection safety are checked, a connection with the ports, plugs, and cables is finalized a transfer charge to share.

### CONCLUSION

The Electric Vehicle Onboard Charge Distribution System is designed for Electric Vehicle to share charges from one EV to other EV (EV2EV). The development of the EVOCDS is an ideal onboard emergency charge system and will provide security and piece of mind to the EV Owner/Operator. For any reason that an EV requires roadside assistance for a boost charge, an EV Owner/Operator can implement a Smart Phone APP to locate Charge2Share participants to assist in a charge to share service program. The EV Owner/Operator can either pay for the Charge to Share services or receive as Gift from other EV Owner/Operator.

The EVOCDS invention comprises of the hardware and software application. The hardware system consists of the EVOCDS module computer that connects to the onboard menu screen, the discharge port, connection cable, and the EV Battery Pack. The hardware contains a computer module that takes charges from the operational EV battery packs and calculates an appropriate distribution charge amounts, where the charge travels through the discharge port and plug along a connection cable and into the EV requiring driving distance charges. The software, Charge2Share program of the EVOCDS Modules data information transfers to the onboard computer menu screen of the EV where the EV Owner/Operator inputs required information to initiate the charge to share activities and transactions. The EV Owner/Operator requiring charge can implement a Smart Phone APP to conduct required inputs information to accept the charge to share transaction. The hardware is designed to contain safety measure for the EV computer to detect as a failed connection; ideal for an accidental plug the cable from the Discharge Port to the Charge Port on the same Electric Vehicle or any technical errors.

The advantage of the EVOCDS to have an EV2EV charge is that charging can be done anywhere from remote area to an urban street from other participating EV Owner/Operator when the EV can not reach the charging station in time for charge. When EV Owner/Operator registers to the website either called “www.EVCharge2Share.com” or “www.evcharge2share.com” or a similar website that service this feature where the EV onboard menu program can be operational. With a depleted charges of an EV requiring just charges to get to the next destination, an EV Owner/Operator can open a Smart Phone APP and search for the nearest EVCharge2Share participants; request a charge distribution service that the EV Owner/Operator can either pay for the Charge2Share service and/or receive as a GIFT if the participant is their friends, coworkers, and/or someone being nice. The EVOCDS also cuts down on the waiting time as the Smart Phone APP will locate any EV Owner/Operator Charge2Share participants within radius and EV Owner/Operator in need of emergency assistance can choose who is closest participant with the best cost.

Future improvements of the EVOCDS would be observed for advancing in software programs, connection port, Smart Phone APP and other essentials for charge to share distribution features; as technology advances and calls for improvements as new findings arises within the EVOCDS and EV technologies. Smart Phone APP and/or Charge2Share program of the EVOCDS can be developed further to provides EV Owner/Operator more incentives and/or other benefits and features, while caring for the environment. Discharge port connections may contain a cable pod about the port for storage along side with compact cables that is convenience to delivers to EV Owner/Operator requiring charge to get to the next destination but not limited to keep up with modern technology advancement.

The EVOCDS with Onboard Menu, EVCharge2Share.com or evcharge2share website, Smart Phone App, data, hardware and software information in the Figures are example of the menu, functions, and demonstrations at this time; for all programs, software, hardware and other essentials are subject to modification to accommodate Electric Vehicle designs, applications, performance, and other essentials in further development.

The goal of the EVOCDS is to make this invention a standard in all Electric Vehicles if not already, for the convenience of EV Owner/Operator to have the piece of mind that should an Electric Vehicle runs out of the charges while on the way to their next destination, where help is within distance radius. All is possible when a large amount if not all EV Owner/Operator participates in the EV2EV or Charge2Share program. An alternative registration could be with the EV Manufacturer website and/or other if the EVOCDS application is implemented in their vehicles.

1. An Electric Vehicle onboard charge distribution system feature that provide charges to another EV Owner/Operator requiring charge (EV2EV).

2. In accordance to claim 1, an Electric Vehicle onboard charge distribution system implement the EV Battery pack to distribute a percentage of driving distance to another EV Owner/Operator requiring charge.

3. In accordance to claim 1, an Electric Vehicle onboard charge distribution system implement a software program for charge to share to allow setup for delivering charges to another EV Owner/Operator requiring charges.

4. In accordance to claim 1, an Electric Vehicle onboard charge distribution system requires EV Owner/Operator registration to a website that provides cash and/or credit incentives for providing charge to share.

5. In accordance to claim 1, an Electric Vehicle onboard charge distribution system allows EV Owner/Operator requiring charges to implement Smart Phone APP (applications) and/or other mean of access of the onboard charge distribution system program when EV is not functional.

6. An Electric Vehicle with separate discharge port fits to a discharge plug containing a feature for quick release after charge.

7. In accordance to claim 6, a discharge plug consists of a release rod situated inside the discharge plug is attached to a release handle.
